(19) United States
(12) Patent Application Publication
(10) Pub. No.: US 2013/0284290 A1
(43) Pub. Date: Oct. 31, 2013

(54) FUEL DELIVERY MODULE AND FLANGE COVER ASSEMBLY

(71) Applicants: JEFFREY S. BASISTA, MILFORD, MI (US); JARROD J. WHITE, STERLING HEIGHTS, MI (US); DANIEL SWAITA, WHITBY (CA)

(72) Inventors: JEFFREY S. BASISTA, MILFORD, MI (US); JARROD J. WHITE, STERLING HEIGHTS, MI (US); DANIEL SWAITA, WHITBY (CA)

(73) Assignee: GM GLOBAL TECHNOLOGY OPERATIONS LLC, DETROIT, MI (US)

(21) Appl. No.: 13/457,286

(22) Filed: Apr. 26, 2012

(51) Int. Cl. E03B 5/00; B23P 17/04

(52) U.S. Cl. 137/565.01; 29/428

(57) ABSTRACT

Methods and apparatus are provided for installing a fuel delivery system in a vehicle fuel tank of the type having a sender opening extending through a top of the tank, a flange cover configured to seal the sender opening, and a sender module mounted within the fuel tank. The sender module includes a fuel pump, a fuel inlet for drawing fuel from the bottom of the tank, a fuel outlet, and a detector module for detecting the fuel level in the tank. A coupling assembly includes an electrical conduit for transferring a fuel level signal to the flange cover, and a hydraulic conduit for transferring fuel from the pump to the flange cover. A retainer is mounted to the bottom of the fuel tank, preferably laterally offset from the vertical axis of the flange cover, and secures the sender module to the tank bottom.

### TECHNICAL FIELD

The present disclosure generally relates to fuel delivery systems for use in motor vehicles, and more particularly relates to a fuel pump housing and flange cover assembly in which the housing module is de-coupled from the flange cover and fixedly mounted to the bottom of the fuel tank.

### BACKGROUND

Presently known fuel delivery systems (fuel pumps) typically include a fuel pump housing (also referred to as a sender bucket) located within a vehicle fuel tank, and a flange cover integrated into a sender opening in the top of the fuel tank. Spring loaded guide rods extend from the flange cover and slidably engage the pump housing to thereby urge it downwardly against the bottom of the fuel tank. In this way, fuel may be drawn from the bottom of the tank through a hydraulic hose (conduit) connecting the fuel pump to the flange cover, and thereafter to the vehicle engine.

Conventional fuel pump housings also incorporate a float mechanism for measuring the fuel level in the tank. An electrical conduit connected between the sender bucket and the flange cover sends a fuel level signal to a display visible to the driver.

Modern vehicle designs are increasingly incorporating lower frontal drag (wind resistance) coefficients to reduce fuel consumption and to aesthetically enhance the vehicle's appearance. With lower windshield profiles and roof lines, the hip point (H-point) of the rear seat passengers is driven downward, resulting in overall compression of the fuel tank height underlying the vehicle frame. The maximum permissible height of the pump housing/flange cover stack is thus limited by the vertical dimension of the fuel tank in the vicinity of the sender opening.

Accordingly, it is desirable to provide a fuel delivery system that may be realized in a motor vehicle fuel tank with a decreased top-to-bottom vertical dimension in the vicinity of the sender opening and/or flange cover. Furthermore, other desirable features and characteristics of the present invention will become apparent from the subsequent detailed description and the appended claims, taken in conjunction with the accompanying drawings and the foregoing technical field and background.

### SUMMARY

An apparatus is provided for pumping fuel from a fuel tank in a motor vehicle. The fuel delivery module includes a sender bucket which houses a fuel pump, a flange cover, and a coupling assembly which typically includes at least one flexible electrical conduit and at least one flexible fluid conduit, wherein the sender bucket is flexibly connected to the flange cover by the coupling assembly, and is preferably not otherwise connected thereto. That is, the spring loaded connecting rods typically used by conventional flange cover/sender bucket combinations to push the bucket to the tank bottom are eschewed, essentially de-coupling the sender bucket from the flange cover. A sender opening is disposed on a top portion of the fuel tank, and a bucket retainer is fixed to a bottom inside surface of the fuel tank. The bucket retainer is configured to removably secure the sender bucket to the bottom inside surface of the tank.

In one embodiment, the sender opening includes an encapsulated ring and the flange cover includes a lock ring. In this way, the flange cover may be releasably locked to the sender opening to thereby provide a fluid and/or vapor seal the sender opening.

Also provided is a fuel delivery system for a vehicle including an enclosed fuel tank having a sender opening extending through a top section of the tank, a flange cover configured to seal the sender opening, a sender module including a fuel pump having an inlet for drawing fuel from the bottom of the fuel tank and an outlet for sending fuel to the flange cover, and a retainer fixed to a bottom inside surface of the fuel tank and configured to secure the sender module to the bottom of the tank. In an embodiment, the sender module and retainer are configured to permit the sender module to be manually snap-fitted into the retainer.

A method is provided for installing a fuel pump in an enclosed fuel tank of a motor vehicle, the fuel tank having a sender opening extending through a top surface, and a bucket retainer on a bottom inside surface. The method includes inserting a sender bucket through the sender opening, locating the retainer and guiding the sender bucket into engagement with the retainer, securing the sender bucket to the retainer, coupling the sender bucket to a flange cover, and sealing the sender opening with the flange cover.

In accordance with some embodiments, the method includes manually inserting the sender bucket with one hand into the fuel tank, and snap-fitting the sender bucket into the retainer using a manually locatable mechanical guide. This may be accomplished by sliding the sender bucket laterally along the bottom inside surface of the fuel tank in a direction substantially orthogonal to a vertical axis of the sender opening. In an alternate embodiment, the sender opening and, hence, the flange cover, may be at an inclined angle with respect to a top horizontal surface of the fuel tank.

The method further includes electrically and/or hydraulically connecting the sender bucket to the flange cover and sealing the sender opening with the flange cover. In an embodiment, the sender opening may be sealed by integrating an encapsulated ring into the sender opening, associating a lock ring with the flange cover, and locking the flange cover into the sender opening by rotationally seating the lock ring into the encapsulating ring.

### DESCRIPTION OF THE DRAWINGS

The present disclosure will hereinafter be described in conjunction with the following drawing figures, wherein like numerals denote like elements, and:

FIG. 1 is a perspective view of a vehicle fuel delivery module, flange cover, and bottom retainer assembly in accordance with embodiments of the present disclosure;

FIG. 2 is a front elevation view of the assembly of FIG. 1 according to the present disclosure;

FIG. 3 is a top plan view illustration of a flange cover installed in a fuel tank according to the present disclosure;

FIG. 4 is a perspective view of a lock ring according to the present disclosure;

FIG. 5 is a perspective view of an encapsulated ring according to the present disclosure;

FIG. 6 is a cross section view of a flange cover and lock ring shown installed in a fuel tank having an encapsulated ring integrated into the sender opening according to the present disclosure;

FIG. 7 is a process flow chart diagram of en exemplary method of installing a fuel pump in accordance with embodiments of the present disclosure; and

FIG. 8 is a perspective view of a vehicle fuel delivery module and bottom retainer assembly in accordance with an alternate embodiment of the present disclosure.

### DETAILED DESCRIPTION

The following detailed description is merely exemplary in nature and is not intended to limit the subject matter of the disclosure or its uses. Furthermore, there is no intention to be bound by any expressed or implied theory presented in the preceding technical field, background, brief summary or the following detailed description.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language.

Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

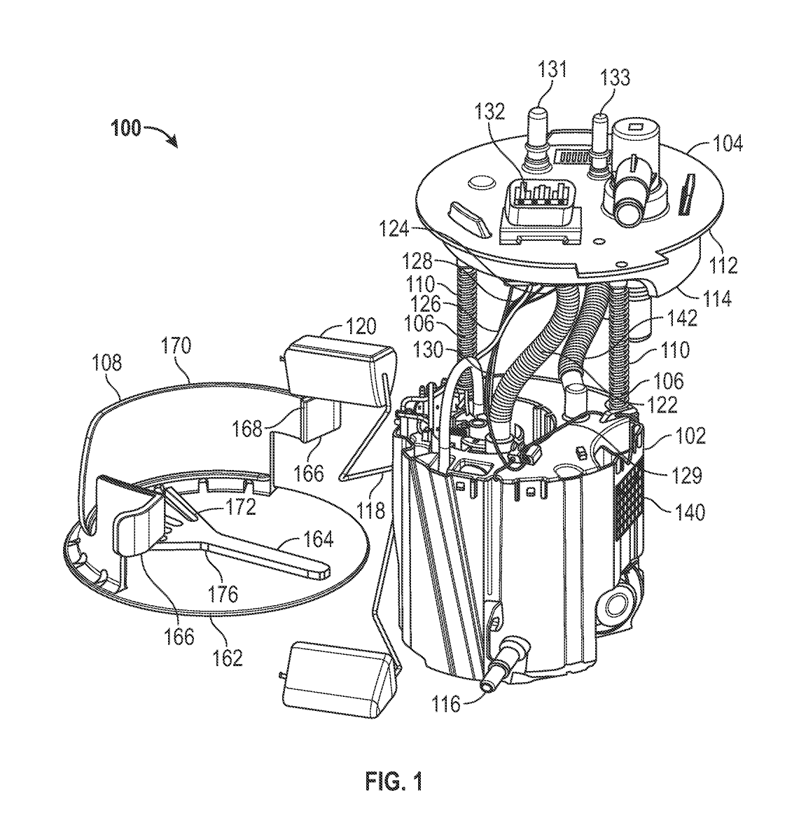

Finally, for the sake of brevity, conventional techniques and components related to vehicle electrical and mechanical parts and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention. It should also be understood that FIGS. 1-6 are merely illustrative and may not be drawn to scale.

FIG. 1 is a simplified schematic representation of an embodiment of a fuel delivery module (FDM) assembly 100 suitable for use in a motor vehicle according to various exemplary embodiments of the present disclosure. The vehicle may be any one of a number of different types of vehicles, such as, for example, a sedan, a wagon, a truck, or a sport utility vehicle (SUV), and may be two-wheel drive (2WD), four-wheel drive (4WD), or all-wheel drive (AWD). Hybrid electric vehicle embodiments may also incorporate any one of, or combination of, a number of different types of engines, such as, for example, a gasoline or diesel fueled combustion engine, a flex fuel vehicle (FFV) engine (i.e., using a mixture of gasoline and alcohol), or a gaseous compound (e.g., hydrogen and/or natural gas) fueled engine.

The de-coupled fuel delivery assemble may also be used in conjunction with fuel tanks for use other than with vehicles, such as stationary engines or any application requiring a pump to deliver a fluid from a storage tank, for example, diesel exhaust fluid (DEF) or fluid stored in a tank and delivered to an injector in the exhaust stream.

Fuel pump assembly 100 includes a fuel delivery module (also referred to as a sender module, sender bucket, or fuel pump housing) 102 and a flange cover 104. In presently known fuel pump systems, a pair of spring loaded connecting rods 106 are connected to the underside of flange cover104, and extend downwardly into guide holes in sender bucket 102. Respective compression springs 110 wound about each rod 106 urge sender bucket 102 away from flange cover 104 to thereby maintain the sender bucket at the bottom of the fuel tank.

This position allows the pump housing to draw fuel from the bottom of the fuel tank, and also maintains axial alignment of the sender bucket with respect to the flange cover mounted in the sender opening of the fuel tank. As the vertical distance between the top and bottom surfaces of the fuel tank changes due to changes in temperature, fuel level, occupant and vehicle stowage weight, and driving conditions, spring loaded connecting rods 106 slidably extend into and out of corresponding holes in sender bucket 102 to continuously urge the sender bucket against the bottom of the fuel tank.

In order to accommodate a fuel tank having a shorter vertical dimension (height) in the vicinity of the sender opening, the connecting rods are eliminated in accordance with various embodiments of this disclosure, thereby allowing a shorter stack height for the flange cover/sender bucket assembly. In accordance with some embodiments, the flange cover and sender bucket remain substantially axially aligned; in other embodiments the sender bucket is displaced laterally from the vertical axis of the flange cover, for example by a few millimeters up to an entire sender opening diameter or more.

With continued reference to FIG. 1, sender bucket 102 includes a primary fuel inlet on its bottom surface (not shown) and a secondary inlet 116, preferably located at or near the bottom of the bucket, for drawing fuel from the fuel tank and into the sender bucket for subsequent pumping to the engine. Sender bucket 102 also includes one or more buoyant float devices 120 disposed on a swing arm 118 pivotably mounted to the side of the bucket.

A first conductor (e.g., a wire) 124 cooperates with float arm (also referred to as a swing arm) 118 and carries a signal indicative of the angular position of float device 120 and, hence, of the fuel level within the fuel tank. A second conductor 126 transmits a reference voltage signal associated with the fuel level indicating circuitry (not shown). A third conductor 128 serves as a ground for one or more of the electrical circuits associated with fuel delivery assembly 100.

Sender bucket 102 further includes a fuel pump 140 and a first hydraulic conduit 122, for example a flexible hose, for pumping fuel from inside the sender bucket 102 to the vehicle engine. In some embodiments, a one or more second hydraulic conduits 142 may be used for return fuel flow. A fourth conductor 130 provides power to pump 140. A fifth wire 129 electrically grounds the various metallic and electrically conductive components of assembly 100.

With continued reference to FIG. 1, flange cover 104 includes a flat, circular, lip portion 112 and a skirt portion 114 descending downwardly therefrom. Flange cover 104 further includes an electronics module 132, a fuel outlet nozzle 131, and a fuel return nozzle 133. Wires 124, 126, 128, 129, and 130 extend from sender bucket 102 and terminate at the underside of electronics module 132. First and second hydraulic conduits 122 and 142 extend from sender bucket 102 and terminate at the undersides of fuel outlet nozzle 131 and fuel return nozzle 133, respectively.

Presently known sender bucket/flange cover combinations typically include a pair of spring loaded guide rods 106 for urging the sender bucket downwardly against the bottom of the fuel tank. In contrast, in accordance with one aspect of the present disclosure, the flange cover/sender bucket combination does not include the guide rods, essentially de-coupling the sender bucket from the flange cover. Rather, the sender bucket is releasably secured to the tank bottom by a retainer 108 in accordance with the present disclosure.

Retainer 108 includes a substantially flat, circular bottom disc 162, a curved circumferential sidewall 170, a pair of manually deformable retainer clips 166 each including a tab 168, and a guide rail 164 which diverges at a transition point 176 to form a fan-out portion 172. Retainer 108 may be temporarily or permanently attached to the inside bottom surface of the fuel tank in the vicinity of the sender opening.

During installation, the installer inserts sender bucket 102 through the sender opening in the top of the fuel tank, and manually locates retainer 108. Sender bucket 102 may then be conveniently snapped into retainer 108 with one hand. Having pre-assembled the electric and hydraulic conduits extending between the flange cover and the sender bucket, the flange cover may then be secured to the sender opening, as described in greater detail below.

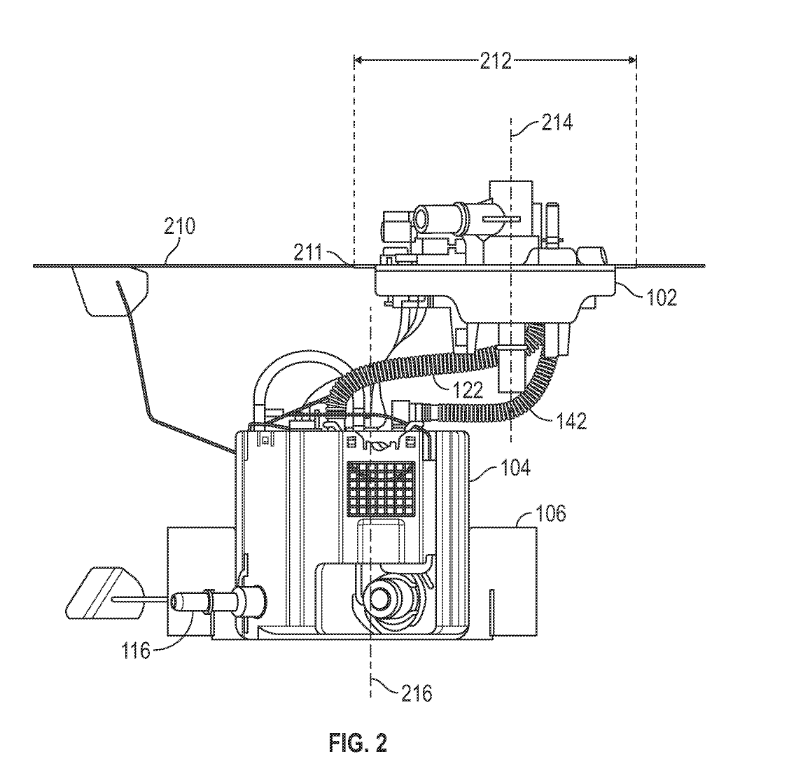

Referring now to FIG. 2, retainer 108 may be affixed in any desired location with respect to the sender opening. More particularly, the top surface 210 of the fuel tank has a substantially circular sender opening 211 characterized by a diameter212 and a vertical axis 214. When installed in retainer 108, sender bucket 102 and retainer 108 have a common vertical axis 216. Retainer 108 may be attached to the fuel tank bottom directly below the sender opening, such that axis 214 substantially coincides with axis 216. Alternatively, axis 216 may be laterally offset or displaced from axis 214 by any convenient distance, for example, on the order of the diameter 212 of the sender opening. In this way, the vertical height of the fuel tank proximate the fuel delivery assembly may be minimized, particularly if axes 214 and 216 are offset by an amount approximately equal to diameter 212.

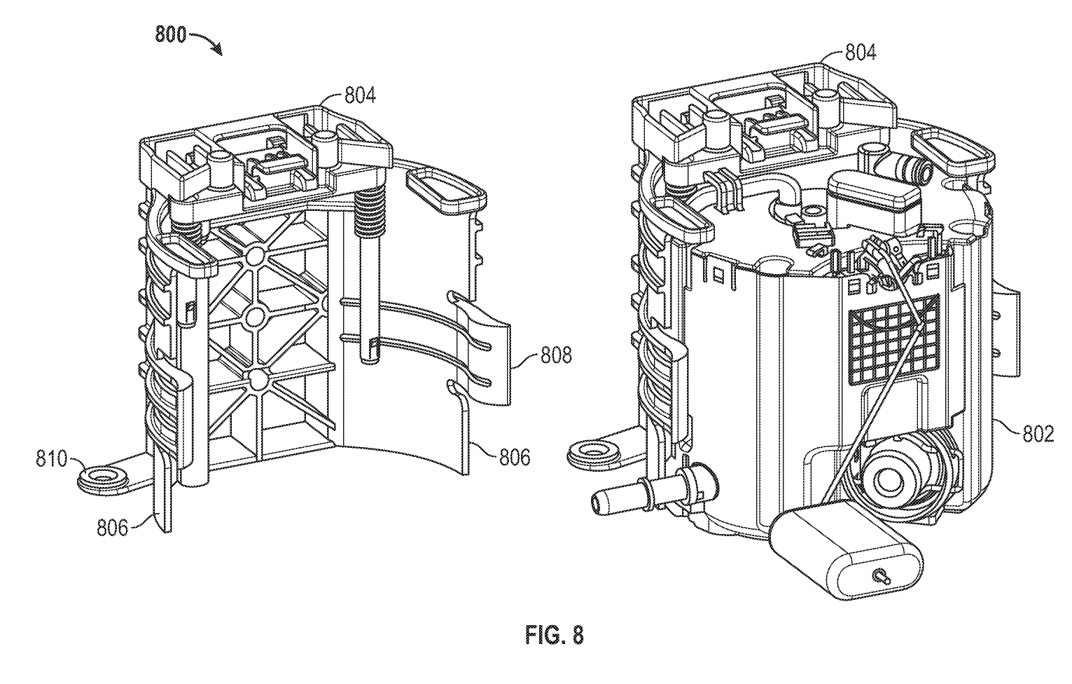

With momentary reference to FIG. 8, a fuel delivery module system 800 includes a fuel delivery bucket 802 and a bucket retainer 804. Bucket retainer 804 includes opposing wings 806, each including a respective tab portion 808. Retainer 804 further includes an extension 810 for securing the retainer to the tank bottom by any suitable mechanism such as, for example, a push-through tab, wing but assembly, or the like. During installation, the fuel delivery bucket may be manually inserted through the sender opening, and manually guided into clasping engagement with wings 806 to removably secure bucket 802 to retainer 804 and, hence, to the bottom of the fuel tank.

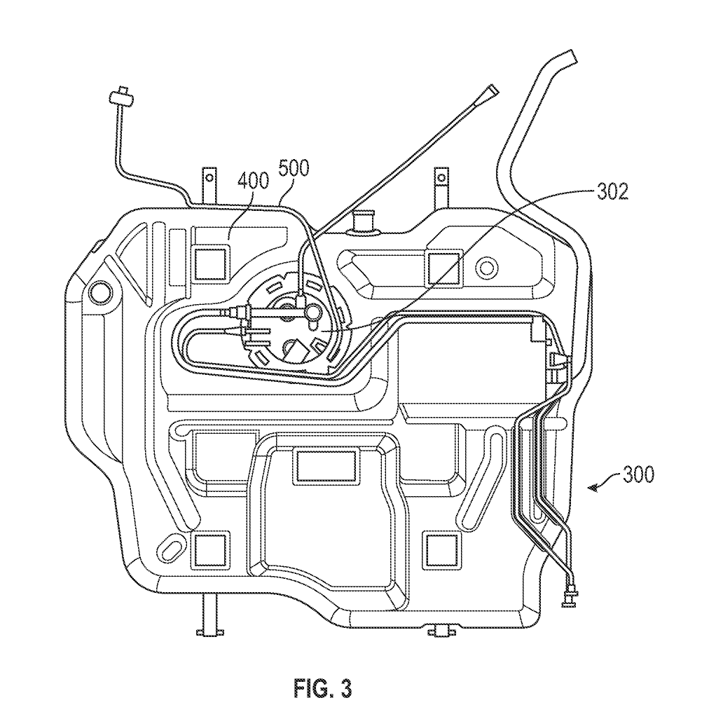

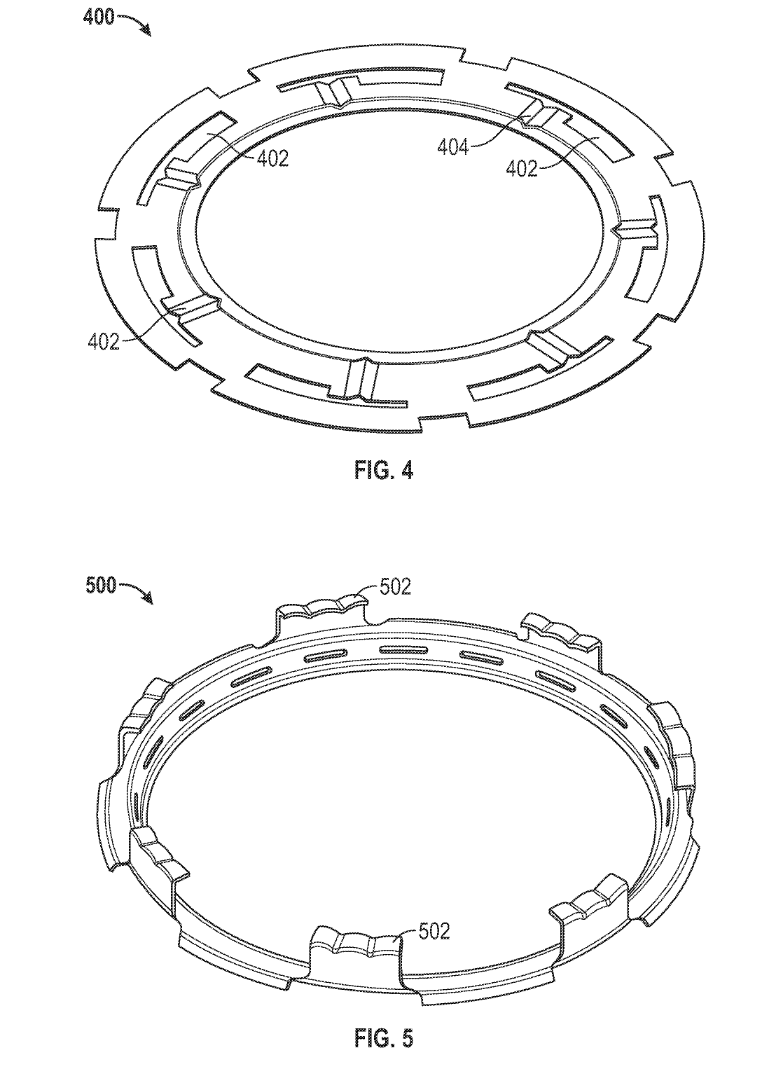

Referring now to FIG. 3, a fuel tank 300 is shown having a flange cover 302 installed into the sender opening (not shown). In the illustrated embodiment, the flange cover is secured within the sender opening via a lock ring (described in greater detail below in conjunction with FIG. 4), and an encapsulated ring 500 (described in greater detail below in conjunction with FIG. 5). It will be appreciated, however, that the flange cover may be secured to the sender opening in any desirable fashion such as, for example, using a “mason jar” (screw cap) assembly, a press fit or tabbed arrangement, a lock washer and gasket, or a screw-type locking assembly, all of which are possible and contemplated by the present disclosure.

FIG. 4 illustrates an exemplary embodiment of a lock ring 400 including a plurality of circumferentially spaced annular openings 402 and adjacent risers 404. FIG. 5 illustrates an exemplary embodiment of an encapsulated ring 500 including a plurality of circumferentially spaced apart tabs 502. Ring 500 may be integrated (e.g., encapsulated) into the sender opening and configured to cooperate with the flange cover to provide a vapor seal across the sender opening.

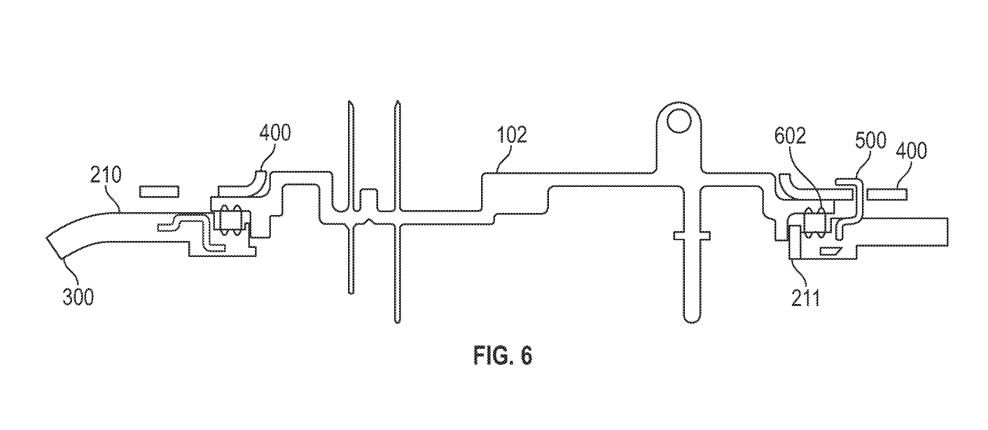

Referring now to FIG. 6, during installation, flange cover 104 is placed over sender opening 211. If desired, a seal or gasket 602 may be interposed between the underside of lip portion 112 of flange cover 104 and upper surface 210 of fuel tank 300 proximate opening 211. Lock ring 400 is then placed over the top perimeter of lip portion 112 such that tabs 502 extend upwardly through respective openings 402 of lock ring 400. Lock ring 400 may then be rotated until tabs 502 engage risers 404, thereby securely locking flange cover 104 in place.

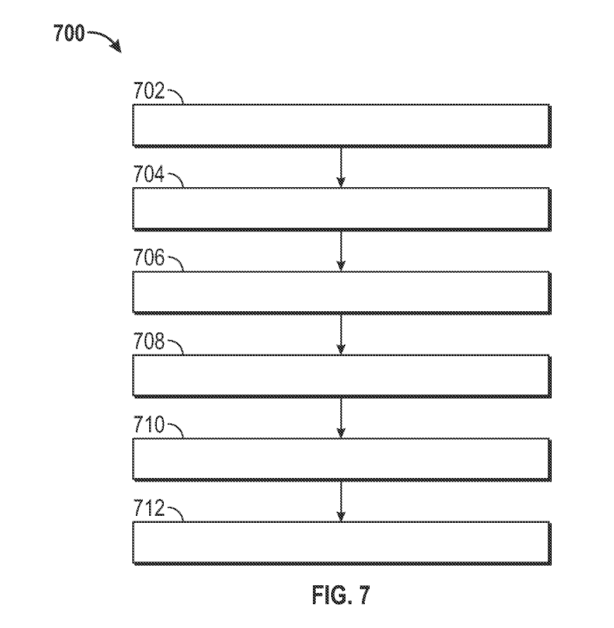

More particularly and with reference to FIG. 7, an exemplary method 700 for installing a fuel delivery assembly in a motor vehicle fuel tank includes inserting (task 702) a sender module through the sender opening of a fuel tank, and locating (task 704) a retainer attached to the bottom of the tank. The method 700 further includes guiding (task 706) the sender bucket into the retainer so that the sender bucket is engaged by the retainer, and securing (task 708) the sender bucket to the bottom of the fuel tank with the retainer.

The method 700 also includes electrically and/or hydraulically coupling (task 710) the sender bucket to the flange cover, and sealing (task 712) the sender opening with the flange cover.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing summary and detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A fuel delivery module for use in a fuel tank of a motor vehicle, comprising:
a sender bucket having an integral fuel pump;
a flange cover; and
a coupling assembly comprising at least one flexible electrical conduit and at least one flexible fluid conduit;
wherein said sender bucket is flexibly connected to said flange cover by said coupling assembly and not otherwise connected thereto.

2. The fuel delivery module of claim 1, further comprising a sender opening disposed on a top portion of said fuel tank, and a bucket retainer fixed to a bottom inside surface of said fuel tank.

3. The fuel delivery module of claim 2, wherein said bucket retainer is configured to removably secure said sender bucket to said bottom inside surface of said fuel tank.

4. The fuel delivery module of claim 3, wherein:
said sender opening comprises at least one of an encapsulated ring and screw threads;
said flange cover comprises at least one of a lock ring and screw threads; and
said flange cover is configured to be releasably locked to said sender opening to thereby seal said sender opening.

5. The fuel delivery module of claim 4, wherein said sender opening has a substantially circular perimeter defining a first vertical axis.

6. The fuel delivery module of claim 5, wherein said sender opening has a diameter in a range of 90 to 200 mm.

7. The fuel delivery module of claim 6, wherein said flange cover comprises a substantially flat circular top panel having a diameter at least as great as the diameter of said sender opening.

8. The fuel delivery module of claim 7, wherein the diameter of said sender opening is about 130 mm.

9. The fuel delivery module of claim 8, wherein said flange cover further comprises a skirt portion which descends downwardly from said substantially flat circular top panel, said flange cover having a second vertical axis substantially coincident with said first vertical axis.

10. The fuel delivery module of claim 9, wherein said bucket retainer is offset from said first vertical axis.

11. The fuel delivery module of claim 10, wherein said bucket retainer is offset from said first vertical axis by an amount approximately equal to the diameter of said sender opening.

12. The fuel delivery module of claim 1, wherein said sender bucket further comprises a fluid level detector, and said coupling assembly is configured to provide a signal to said flange cover indicative of the level of fuel within said fuel tank.

13. A fuel delivery system for a vehicle, comprising:
an enclosed fuel tank having a sender opening extending through a top section of said fuel tank;
a flange cover configured to seal said sender opening;
a sender module including a fuel pump having an inlet for drawing fuel from the bottom of said fuel tank and an outlet for sending fuel to said flange cover; and
a retainer fixed to a bottom inside surface of said fuel tank and configured to secure said sender module to said fuel tank.

14. The fuel delivery system of claim 13, wherein said sender module and said retainer are configured to permit said sender module to be manually snap-fitted into said retainer.

15. A method of installing a fuel pump in an enclosed fuel tank of a motor vehicle, the fuel tank having a sender opening extending through a top portion thereof and a bucket retainer on a bottom inside surface thereof, the method comprising:
inserting a sender bucket through the sender opening;
securing the sender bucket to the bucket retainer;
coupling the sender bucket to a flange cover; and
sealing the sender opening with the flange cover.

16. The method of claim 15, wherein inserting comprises manually inserting the sender bucket with one hand into the fuel tank.

17. The method of claim 15, wherein securing comprises snap-fitting the sender bucket into the bucket retainer using a manually locatable mechanical guide.

18. The method of claim 17, wherein securing further comprises sliding the sender bucket laterally along the bottom inside surface of the fuel tank substantially orthogonal to a vertical axis defined by the sender opening.

19. The method of claim 15, wherein coupling comprises electrically and hydraulically connecting the sender bucket to the flange cover.

20. The method of claim 15, wherein sealing comprises:
integrating an encapsulated ring into the sender opening;
integrating a lock ring into the flange cover; and
locking the flange cover into the sender opening by rotationally seating the lock ring into the encapsulating ring.
